(19) United States
(12) Patent Application Publication
(10) Pub. No.: US 2025/0321887 A1
(43) Pub. Date: Oct. 16, 2025

(54) DATA RESTORATION METHOD AND DEVICE IN FLASH MEMORY-BASED FILE SYSTEM

(71) Applicant: AJOU UNIVERSITY INDUSTRY-ACADEMIC COOPERATION FOUNDATION, Suwon-si (KR)

(72) Inventors: Taeshik SHON, Gyeonggi-do (KR); Yeonghun SHIN, Gyeonggi-do (KR)

(73) Assignee: AJOU UNIVERSITY INDUSTRY-ACADEMIC COOPERATION FOUNDATION, Suwon-si (KR)

(21) Appl. No.: 19/176,413

(22) Filed: Apr. 11, 2025

(30) Foreign Application Priority Data
Apr. 12, 2024 (KR) 10-2024-0049191

(51) Int. Cl. G06F 12/02

(52) U.S. Cl. CPC G06F 12/0246

(57) ABSTRACT

A method for restoring data in a flash memory-based file system according to an aspect of the present disclosure includes receiving a file system image file; analyzing a metadata structure of the image file; and generating a target file to be restored based on the analysis of the metadata structure.

### CROSS-REFERENCE TO RELATED APPLICATION

This application claims the benefit of Korean Patent Application No. 10-2024-0049191, filed on Apr. 12, 2024, in the Korean Intellectual Property Office, the disclosures of which are incorporated herein in its entirety by reference.

### BACKGROUND

### 1. Field

The present disclosure relates to a data restoration method and device in a flash memory-based file system. More particularly, the present disclosure relates to a method and device for recovering deleted files by analyzing environments that utilize a flash memory-based file system such as the Flash-Friendly File System (F2FS).

Example embodiments of the present disclosure relate to a national research and development project. Information on the national research and development project has subject identification No. 1711170476, subject No. 2022-0-01022, project name “Development of core information security technology”, and subject title “Development of Collection and Integrated Analysis Methods of Automotive Inter/Intra System Artifacts through Construction of Event-based experimental system”.

### 2. Description of the Related Art

A flash memory-based file system is a file system specialized for NAND flash-based storage devices such as eMMC, SSD, and UFS. It is based on a Log Structured File System (LFS) and has a characteristic of separating nodes and data blocks by their frequency of updates into hot, warm, and cold segments for recording. This allows small-sized write operations to be grouped and written at once, thereby reducing seek time and improving performance. However, due to the sequential write approach, the inode map—which is essential for reading file data—ends up being placed at the last position. This structure was previously unsuitable for HDDs and thus not used, but is now adopted in file systems for flash memory.

In contrast, conventional file systems optimized for HDDs are based on Fast File System (FFS), which stores inodes and data blocks in the same cylinder or cylinder group to make the most of the HDD's structure.

File system forensics refers to a series of procedures for collecting electronic evidence remaining in electronic devices during investigations. To achieve this, methods for analyzing the metadata structure and file management approach of the file system used in electronic devices are required. While sufficient research and recovery methods exist for metadata structures of file systems like NTFS in Windows and Ext4 in Linux/Unix, research on flash memory-based file systems remains insufficient.

Accordingly, it is difficult to apply conventional digital forensic methods developed for HDD-based file systems to flash memory-based file systems.

Moreover, new file systems are continuously being introduced, and like operating systems or software, file systems are also subject to ongoing updates. As such, it is an important challenge to devise forensic methods that adapt to such changes. In particular, when a new file system optimized for environments like flash memory is introduced, applying existing forensic technologies may prove difficult.

Recently, the use of flash memory has increased, especially in the latest smartphones, leading to wider adoption of flash memory-based file systems. Consequently, there is a growing need for digital forensic methods applicable to modern smartphones.

When the latest smartphones operate based on flash memory-based file systems such as F2FS, conventional technologies alone may not be sufficient for effective digital evidence collection.

### SUMMARY

The problem to be solved by the present disclosure is to provide a method for analyzing the metadata structure of a flash memory-based file system.

Another problem to be solved by the present disclosure is to provide a method for deriving a file management scheme based on the analyzed metadata structure and restoring deleted data.

A method for restoring data in a flash memory-based file system according to an aspect of the present disclosure may include: receiving a file system image file; analyzing a metadata structure of the image file; and generating a target file to be restored based on the analysis of the metadata structure.

According to an aspect, the metadata structure may include a superblock, a checkpoint (CP), a segment information table (SIT), a node address table (NAT), a segment summary area, and a main area.

According to an aspect, the step of analyzing the metadata structure of the image file may include analyzing the superblock; analyzing the NAT; and analyzing the main area.

According to an aspect, the superblock may be located at offset 0×400.

According to an aspect, the superblock may include block size, start addresses of each metadata structure, the total number of segments, the total number of sections, and the root inode number.

According to an aspect, the checkpoint may record the current state of the system, including segment allocation, node allocation, and the state of currently active segments.

According to an aspect, in the event of a system interruption, the method may further include performing recovery using a previously recorded checkpoint.

According to an aspect, the step of analyzing the NAT may include analyzing the NAT based on the start address of the node address table identified during the superblock analysis step, and the NAT may include inode numbers and address information for all node blocks stored in the main area.

According to an aspect, the step of analyzing the main area may include analyzing the main area based on the start address of the main area identified during the superblock analysis step, and the main area may store nodes and data classified into hot, warm, and cold categories according to update frequency.

According to an aspect, the step of analyzing the main area may include generating a node block mapping table; and determining whether the mapping for all directories and files is complete, and if mapping is complete, the node block mapping may be terminated.

According to an aspect, if the mapping for all directories and files is not complete, the method may further include: searching for node blocks in subdirectories; searching for allocated node blocks; adding the node blocks to the mapping table; and returning to the step of determining whether the mapping is complete.

According to an aspect, the step of generating the target file to be restored may include determining whether to perform restoration of deleted data; in case of restoring deleted data, analyzing the segment information table (SIT), which includes the number of blocks for the cleaning process and bitmap information for the blocks; acquiring and analyzing bitmap information; deriving deleted files; and searching for node blocks of the data. If the deleted data is to be restored, the step may include searching for the node blocks of the data.

According to an aspect, the step of generating the target file to be restored may further include, after searching for the node blocks of the data: acquiring the address where the actual data is stored; acquiring the actual stored data based on the address; deriving a filename of the restored data by mapping the inode number in the directory node block based on the node block mapping table; and generating the target file to be restored based on the actual stored data and the filename.

A computer-readable storage medium storing at least one program according to an aspect may include instructions for executing the above-described method.

An apparatus according to an aspect may include: at least one processor; and a computer-readable storage medium storing at least one program configured to be executed by the at least one processor, wherein the at least one program includes instructions for executing the above-described method.

### BRIEF DESCRIPTION OF THE DRAWINGS

The following brief description of the drawings is provided to facilitate a better understanding of the drawings referenced in the present disclosure.

FIG. 1 is a schematic view illustrating an example of a metadata structure of a Flash-Friendly File System (F2FS).

FIG. 2 is a schematic block diagram illustrating a hardware configuration of an electronic device in which a data restoration method for a flash memory-based file system according to an embodiment of the present disclosure may be performed.

FIG. 3 is a flowchart for explaining a data restoration method for a flash memory-based file system according to an embodiment of the present disclosure.

FIG. 4 is a flowchart for explaining a main area analysis step of FIG. 3.

FIG. 5 is a flowchart for explaining a deleted data restoration step of FIG. 3.

FIG. 6 is a view illustrating major file system information obtainable from the superblock.

FIG. 7 is a view illustrating information obtainable from the checkpoint.

FIG. 8 is a view illustrating information obtainable from the segment information table.

FIG. 9 is a view illustrating information obtainable from the node address table (NAT).

FIG. 10 is a view illustrating information obtainable from the segment summary area.

FIG. 11A is a view illustrating types of segments among information obtainable from the main area.

FIG. 11B is a view illustrating node information among information obtainable from the main area.

### DETAILED DESCRIPTION

Exemplary embodiments according to the technical idea of the present disclosure are provided to more completely explain the technical idea of the present disclosure to those of ordinary skill in the art. The following embodiments may be modified in various other forms, and the scope of the technical idea of the present disclosure is not limited to the following embodiments. Rather, these embodiments are provided to make the present disclosure more thorough and complete and to fully convey the technical idea of the present disclosure to those skilled in the art.

In the present disclosure, terms such as “first” and “second” may be used to describe various elements, regions, layers, portions, and/or components, but these elements, parts, regions, layers, portions, and/or components should not be limited by these terms. These terms do not imply any particular order, hierarchy, or importance, but are only used to distinguish one element, region, layer, portion, or component from another. Therefore, a “first” element, region, portion, or component described below may also be referred to as a “second” element, region, portion, or component without departing from the scope of the present disclosure.

Unless otherwise defined, all terms used herein (including technical and scientific terms) have the same meaning as commonly understood by one of ordinary skill in the art to which the present disclosure belongs. Terms generally used in dictionaries should be interpreted to have meanings consistent with the contextual meaning in the relevant art, and should not be interpreted in an overly idealized or formal sense unless expressly defined herein.

Where certain embodiments are implemented in different forms, the order of specific steps or processes may differ from the order described. For example, two processes or steps described in succession may be performed concurrently or in reverse order without departing from the scope of the present disclosure.

The terms “unit,” “device,” “module,” etc., as used herein refer to a unit for processing at least one function or operation, and may be implemented by hardware, such as a processor, microprocessor, microcontroller, CPU, GPU, AP, NPU, APU, DSP, ASIC, or FPGA, or by software, or by a combination of hardware and software. They may also be implemented in combination with a memory storing data necessary for processing at least one function or operation.

In addition, distinctions among the components described herein are for convenience of description based on primary functions. Two or more components described below may be combined into one component, or a single component may be divided into two or more components based on more detailed functions. Also, each component may perform, in addition to its own primary functions, some or all of the functions performed by other components. Likewise, a portion of a function assigned to a component may be performed by another component.

As used herein, the term “and/or” includes any and all combinations of one or more of the associated listed elements.

Hereinafter, embodiments of the present disclosure will be described in detail with reference to the accompanying drawings.

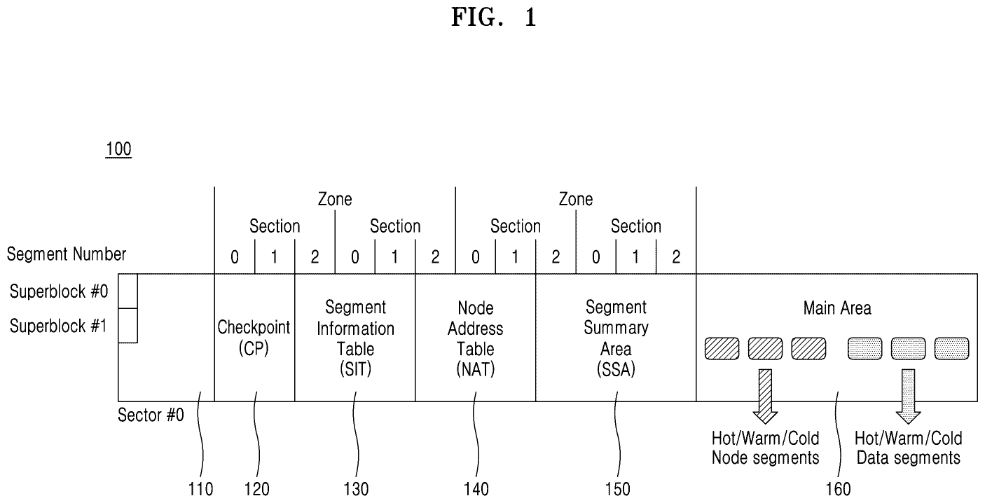

FIG. 1 is a schematic view illustrating an example of a metadata structure (100) of a Flash-Friendly File System (F2FS).

F2FS is a Linux file system designed for flash memory storage. F2FS may be used mainly in flash-based storage devices such as Solid State Drives (SSD) and embedded MultiMediaCards (eMMC). F2FS is optimized for performance and flash memory lifespan by taking into account characteristics of flash memory. F2FS also employs efficient methods for managing metadata and data to save storage space, uses optimized memory allocation and algorithms suited for flash devices to offer fast input/output speeds, and is enhanced in terms of stability and durability to prevent data loss.

According to an embodiment of the present disclosure, the metadata structure may include a superblock 110, a checkpoint (CP) 120, a segment information table (SIT) 130, a node address table (NAT) 140, a segment summary area 150, and a main area 160. The metadata structure may be divided into sections and zones.

Analysis of the file system metadata structure begins with the superblock 110, as in other file systems. After acquiring essential file system analysis information, the analysis proceeds to other metadata structures.

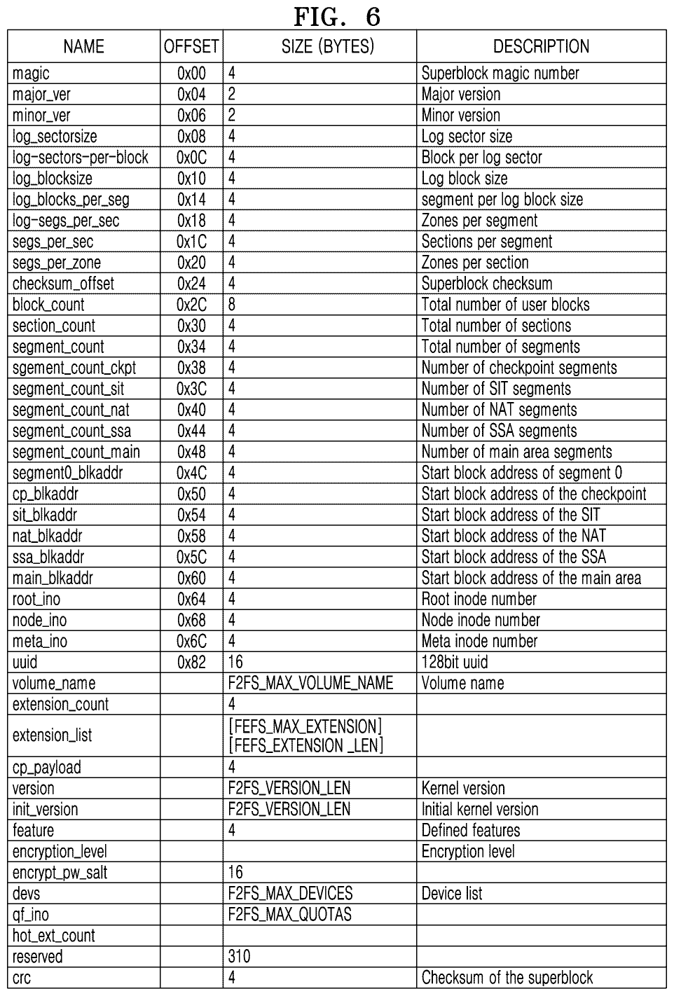

The superblock 110 may be located at offset 0×400 . The superblock 110 may include core metadata information used in the file system, such as block size, start addresses of each metadata structure, total number of segments, total number of sections, and root inode number. FIG. 6 specifically illustrates major file system information obtainable from the superblock 110.

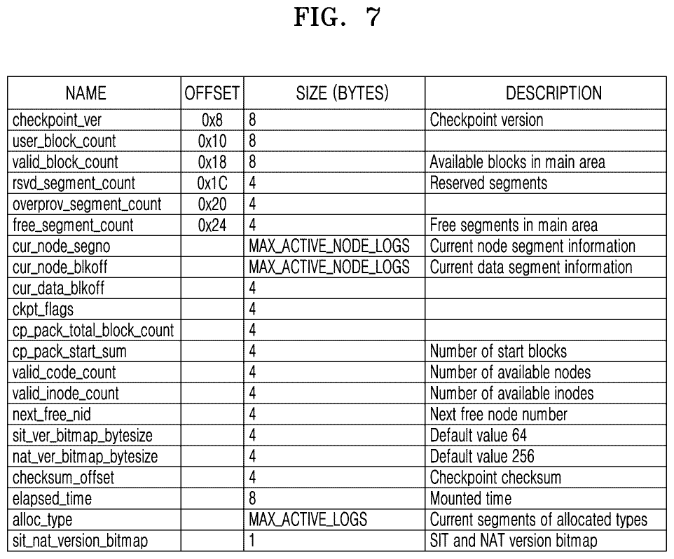

The checkpoint 120 is a structure used to maintain data consistency and records the current system state including segment allocation, node allocation, and active segment status. If a system interruption occurs, recovery may be performed using the previously recorded checkpoint. The system may perform analysis on the checkpoint to obtain and analyze information such as checkpoint version, current node segment information, and current data segment information. Various types of information obtainable from the checkpoint 120 are illustrated in FIG. 7.

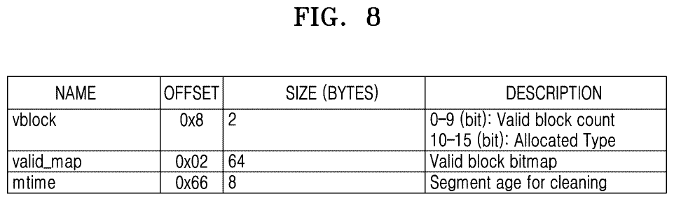

The segment information table 130 may include, in the corresponding metadata structure, the number of blocks and bitmap information for cleaning processes. Various types of information obtainable from the segment information table 130 are illustrated in FIG. 8.

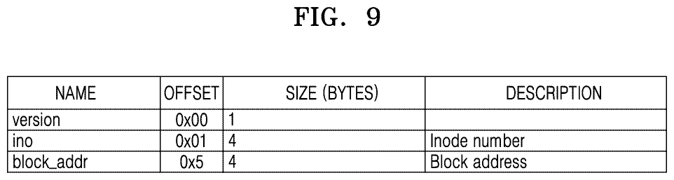

The node address table (NAT) 140 includes inode numbers and address information for all node blocks stored in the main area. Various types of information obtainable from the node address table 140 are illustrated in FIG. 9.

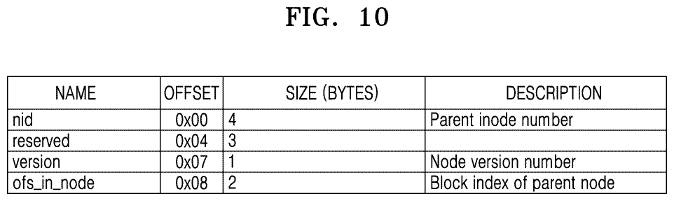

The segment summary area 150 stores summary information indicating the owner of each block in the main area and plays a role in identifying upper node blocks before valid blocks are migrated. Summary data stored in the metadata structure may be acquired, and parent inode numbers and locations of each node may be acquired and analyzed. Various types of information obtainable from the segment summary area 150 are illustrated in FIG. 10.

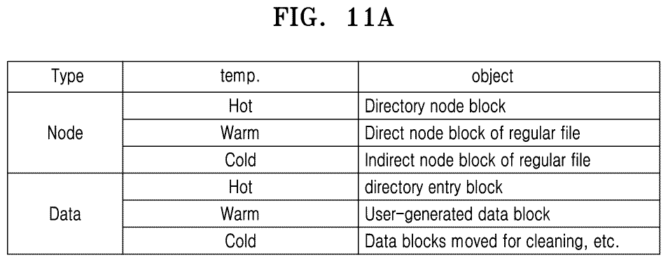

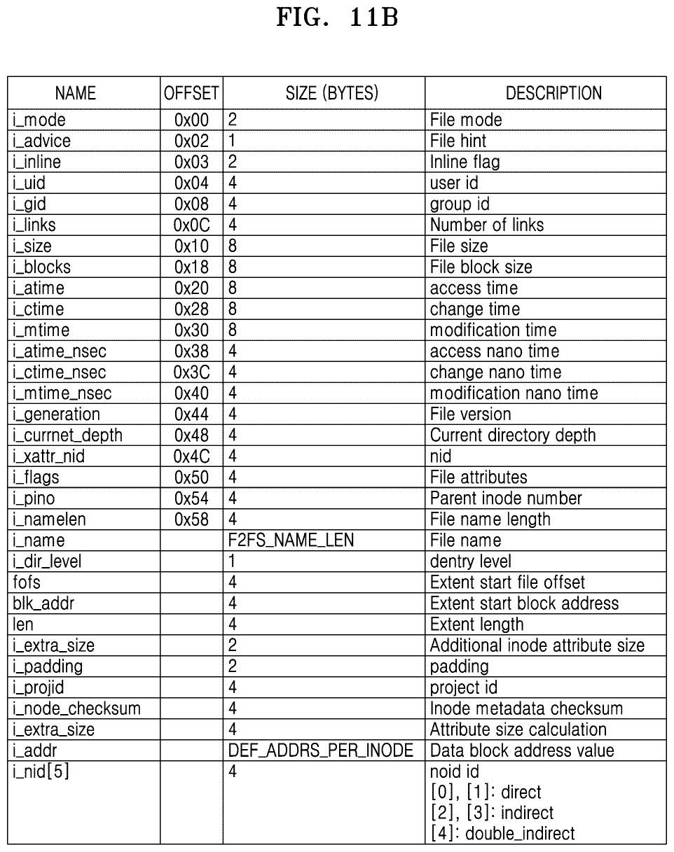

The main area 160 stores nodes and data categorized into hot, warm, and cold segments based on update frequency. FIGS. 11A and 11B respectively illustrate segment types and node information obtainable from the main area 160.

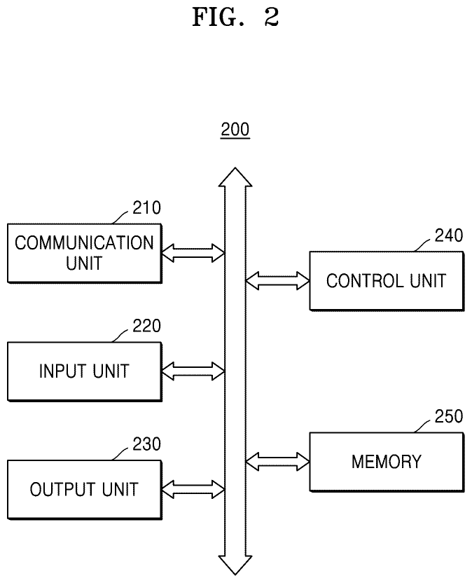

FIG. 2 is a schematic block diagram illustrating a hardware configuration of an electronic device in which a data restoration method for a flash memory-based file system according to an embodiment of the present disclosure may be performed.

The hardware configuration of the electronic device 200 shown in FIG. 2 may correspond to that shown in FIG. 1. Referring to FIG. 2, the electronic device 200 may include a communication unit 210, an input unit 220, an output unit 230, a control unit 240, and a memory 250. The configuration shown in FIG. 2 is one example for the convenience of explanation, and the electronic device 200 may include more or fewer components than illustrated.

The communication unit 210 may include one or more communication modules enabling the electronic device 200 to connect to a network and communicate with other terminals or servers. The communication modules may include mobile communication modules such as LTE or 5G, wireless communication modules such as Wi-Fi or Bluetooth, and/or various other wired or wireless communication modules.

The input unit 220 may be configured to acquire information such as user input, video, and audio, and may include various input means such as mechanical/electronic input devices, a camera, and a microphone.

The output unit 230 may provide information to a user by generating outputs related to visual, auditory, or tactile senses, and may include a display, speaker, vibration module, and the like.

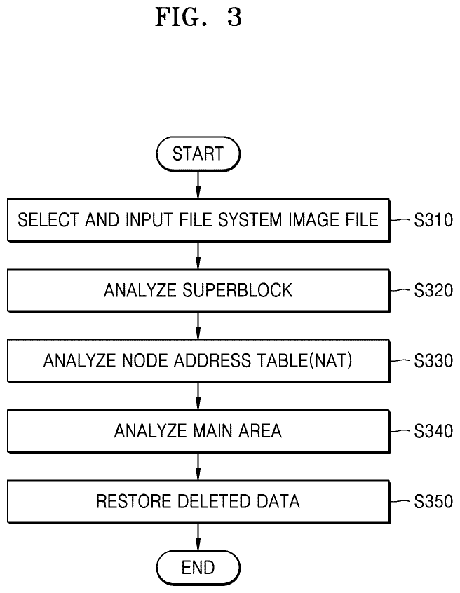

The control unit 240 may control overall operations of the electronic device 200. It may process signals, data, or information input or output through the aforementioned components or provide specific information or functions based on various applications or algorithms stored in the memory 250. For example, the control unit 240 may correspond to a component that performs the steps described in FIG. 3. The control unit 240 may include at least one processor and/or at least one programmable circuit, and may be implemented by hardware such as a CPU, AP, MCU, GPU, NPU, integrated circuit, ASIC, or FPGA.

The memory 250 may store programs and data necessary for operating the electronic device 200. It may also store data generated or acquired through the control unit 240. The memory 250 may include ROM, RAM, flash memory, SSD, HDD, or a combination thereof.

FIG. 3 is a flowchart for explaining a data restoration method for a flash memory- based file system according to an embodiment of the present disclosure.

The method may include a step of selecting and inputting an image file from the file system (S310).

The method may include a step of analyzing a superblock (S320).

For example, the step of analyzing the superblock may be performed by acquiring and analyzing major metadata information used in the file system from the superblock located at offset 0×400, such as block size, start addresses of each metadata structure, total number of segments, total number of sections, and root inode number.

The method may include a step of analyzing a node address table (NAT) (S330).

For example, the step of analyzing the NAT may include analyzing the NAT based on the start address of the node address table identified in the superblock analysis step. The NAT stores inode numbers and address information for all node blocks saved in the main area. The electronic device 200 may acquire and analyze the stored information to use in analyzing the main area.

The method may include a step of analyzing a main area (S340).

For example, the step of analyzing the main area may include analyzing the main area based on the start address of the main area identified in the superblock analysis step. The main area stores nodes and data classified as hot, warm, or cold based on update frequency. First, the electronic device 200 performs analysis on node blocks. Node blocks may be located by calculating the node block addresses stored in the NAT area. The found node block contains information on the data block corresponding to a specific inode number. Node blocks may be categorized into directory node blocks, regular file node blocks, and inline node blocks. A directory node block may contain names of subdirectories and files stored in the corresponding directory. A file node block may contain information about a file and the location of actual data blocks. An inline node block may be used when the data size is small enough to be written directly into the node block, in which case the actual file data can be read directly from the node block.

The method may include a step of restoring deleted data (S350).

For example, based on the information obtained from the superblock analysis step, the electronic device 200 may proceed with the data restoration step. The electronic device 200 may utilize the inode number and node block location information identified in the NAT analysis step to perform analysis in the main area analysis step. First, the electronic device 200 may analyze directory node blocks to construct a tree structure of all files present in the file system. Then, electronic device 200 may analyze node blocks for each file in each directory to map the inode number of the node to the location of actual data blocks. If restoring non-deleted specific data, the electronic device 200 may obtain the location information stored in the relevant node block, analyze the location information, and retrieve the actual data. The filename may be acquired by mapping the inode number in the directory node block. When restoring deleted data, the electronic device 200 may utilize the segment information table (SIT). The SIT may be used for cleaning deleted files and includes bitmap information from which deleted files can be derived. The remaining restoration process follows the same procedure as restoring non-deleted data.

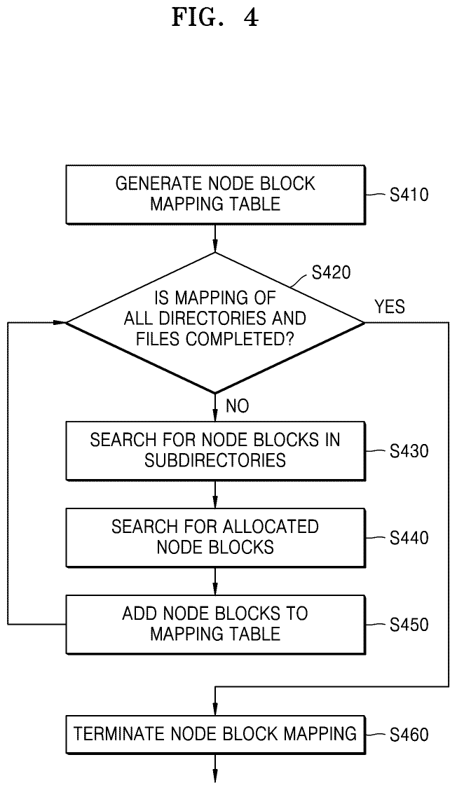

FIG. 4 is a flowchart for explaining the main area analysis step (S340) of FIG. 3.

The electronic device 200 may generate a node block mapping table (S410).

The electronic device 200 may determine whether mapping for all directories and files has been completed (S420). If the mapping has been completed, the electronic device 200 may terminate node block mapping in step S460.

The electronic device 200 may search for node blocks in subdirectories (S430).

The electronic device 200 may search for allocated node blocks (S440) and may add the discovered node blocks to the mapping table (S450).

If mapping for all directories and files has not been completed (NO, S420), the electronic device 200 may repeat steps S430 through S450.

Once mapping for all directories and files has been completed (YES, S420), the electronic device 200 may terminate the node block mapping (S460).

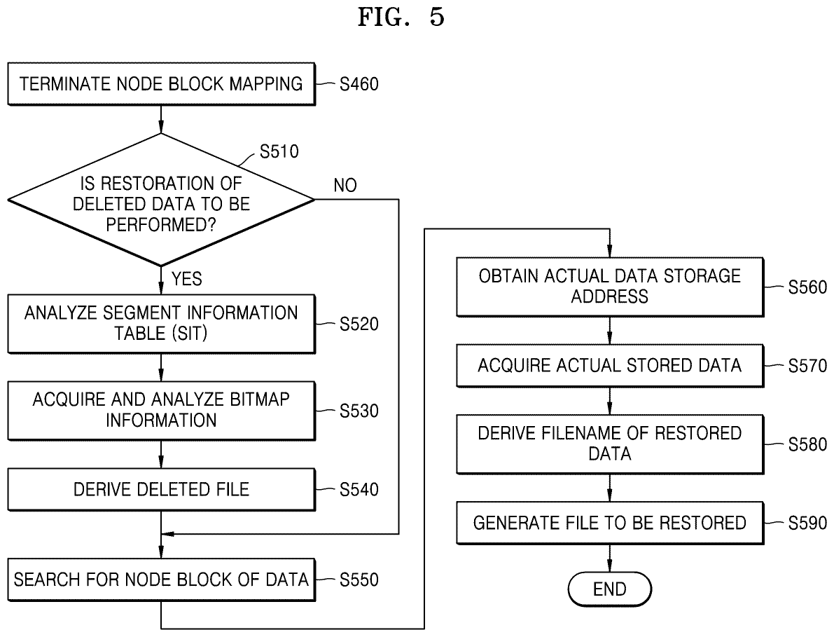

FIG. 5 is a flowchart for explaining the deleted data restoration step (S350) of FIG. 3.

After the node block mapping is terminated in step S460, the electronic device 200 may determine whether to perform restoration of deleted data (S510).

If restoring non-deleted data, the electronic device 200 may proceed to the step of searching for the node block of the relevant data (S550).

If restoring deleted data, the electronic device 200 may analyze the segment information table (SIT) (S520). The SIT analysis step may be performed based on the start address of the segment information table identified in the superblock analysis step. This metadata structure may include the number of blocks for the cleaning process and bitmap information for the blocks. The electronic device 200 may acquire and analyze the number of valid blocks and bitmap information.

The electronic device 200 may acquire and analyze the allocated bitmap information (S530), and may derive deleted files based on the analysis result (S540).

The electronic device 200 may search for the node blocks of the data, whether deleted or not (S550 to S560).

The electronic device 200 may acquire actual stored data based on the obtained data storage address (S570), and may derive the filename of the restored data based on the node block mapping table (S580).

Based on the actual stored data and the derived filename obtained in steps S570 and S580, the electronic device 200 may generate a target file to be restored (S590).

FIG. 6 is a view illustrating major file system information obtainable from the superblock. FIG. 7 is a view illustrating information obtainable from the checkpoint. FIG. 8 is a view illustrating information obtainable from the segment information table. FIG. 9 is a view illustrating information obtainable from the node address table (NAT). FIG. 10 is a view illustrating information obtainable from the segment summary area.

The tables of major file system information obtainable from the superblock 110 to the segment summary area 150 may be categorized by name, offset, size (bytes), and description.

FIG. 11A is a view illustrating types of segments among the information obtainable from the main area. FIG. 11B is a view illustrating node information among the information obtainable from the main area.

The table of segment types obtainable from the main area 160 may be classified into type, temp., and object. The table of node information obtainable from the main area 160 may be categorized by name, offset, size (bytes), and description.

According to an embodiment of the present disclosure, in the current environment where flash memory-based file systems are installed and operated on modern smartphones due to the emergence of flash memory-based file systems, the present disclosure may be usefully applied by various digital forensic institutions, including investigative agencies. Furthermore, if sufficient research is not conducted on the latest file systems, it may become difficult for requesting institutions to collect important digital evidence. According to the present disclosure, economic and societal advantages may be expected in the field of digital forensic investigations.

Moreover, given the recent trend of flash memory being used in most electronic devices, including personal desktop environments, and the increasing use of flash memory-based file systems, the present disclosure is expected to be applicable not only to smartphones but also to a broader range of electronic devices that will use flash memory in the future.

The effects obtainable through the technical idea of the present disclosure are not limited to the above-mentioned effects, and other effects not explicitly mentioned will be clearly understood by those skilled in the art from the following description.

The descriptions of the above embodiments are merely illustrative examples provided with reference to the drawings for more thorough understanding of the present disclosure, and should not be interpreted as limiting the technical scope of the present disclosure.

Furthermore, it will be apparent to those of ordinary skill in the art that various modifications and alterations may be made without departing from the fundamental principles of the present disclosure.

What is claimed is:

1. A method for restoring data in a flash memory-based file system, the method comprising:
receiving a file system image file;
analyzing a metadata structure of the image file; and
generating a target file to be restored based on the analysis of the metadata structure.

2. The method of claim 1, wherein the metadata structure includes a superblock, a checkpoint (CP), a segment information table (SIT), a node address table (NAT), a segment summary area, and a main area.

3. The method of claim 2, wherein the analyzing of the metadata structure comprises:
analyzing the superblock;
analyzing the NAT; and
analyzing the main area.

4. The method of claim 3, wherein the superblock is located at offset 0×400.

5. The method of claim 3, wherein the superblock includes a block size, start addresses of each metadata structure, a total number of segments, a total number of sections, and a root inode number.

6. The method of claim 2, wherein the checkpoint records a current state of the system including segment allocation, node allocation, and current active segment status.

7. The method of claim 6, further comprising:
in response to a system interruption, performing recovery using a previously recorded checkpoint.

8. The method of claim 3, wherein the analyzing of the NAT comprises:
analyzing the NAT based on a start address of the node address table identified during the analyzing of the superblock,
wherein the NAT includes inode numbers and address information of all node blocks stored in the main area.

9. The method of claim 8, wherein the analyzing of the main area comprises:
analyzing the main area based on a start address of the main area identified during the analyzing of the superblock,
wherein the main area stores nodes and data classified into hot, warm, and cold categories according to update frequency.

10. The method of claim 8, wherein the analyzing of the main area comprises:
generating a node block mapping table; and
determining whether mapping for all directories and files has been completed,
wherein the node block mapping is terminated if the mapping is completed.

11. The method of claim 10, wherein if the mapping for all directories and files is not completed, the method further comprises:
searching for node blocks in subdirectories;
searching for allocated node blocks;
adding the node blocks to the mapping table; and
returning to the step of determining whether the mapping is completed.

12. The method of claim 3, wherein the generating of the target file to be restored comprises:
determining whether to perform restoration of deleted data,
wherein, in case of restoring deleted data, the method comprises:
analyzing a segment information table (SIT) including the number of blocks for a cleaning process and bitmap information of the blocks;
acquiring and analyzing the bitmap information;
deriving deleted files; and
searching for node blocks of the derived data,
and wherein, in case of restoring non-deleted data, the method comprises:
searching for the node blocks of the data.

13. The method of claim 12, wherein the generating of the target file to be restored further comprises:
after searching for the node blocks of the data,
acquiring an address at which actual data is stored;
acquiring the actual stored data based on the acquired address;
deriving a filename of the restored data by mapping an inode number in a directory node block based on the node block mapping table; and
generating the target file to be restored based on the actual stored data and the derived filename.

14. A non-transitory computer-readable storage medium storing one or more programs,
wherein the one or more programs comprise instructions for performing the method of claim 1.

15. An apparatus comprising:
at least one processor; and
a non-transitory computer-readable storage medium storing one or more programs configured to be executed by the at least one processor,
wherein the one or more programs comprise instructions for executing the method of claim 1.
